(19) United States
(12) Patent Application Publication
(10) Pub. No.: US 2012/0274809 A1
(43) Pub. Date: Nov. 1, 2012

(54) ELECTRONIC DEVICE AND LUMINANCE ADJUSTING METHOD THEREOF

(76) Inventors: Chia-Hsin YANG, Taipei (TW); Yi-Hsiu Lee, Taipei (TW); Yang-Po Chiu, Taipei (TW)

(21) Appl. No.: 13/458,077

(22) Filed: Apr. 27, 2012

(30) Foreign Application Priority Data
Apr. 29, 2011 (TW) 100115140

(51) Int. Cl. H04N 9/68

(52) U.S. Cl. 348/234; 348/E09.053

(57) ABSTRACT

A luminance adjusting method of an electronic device is disclosed. The electronic device includes a light sensor, a control module, a memory and a light source module. The memory stores predetermined ambient luminance-light source luminance corresponding information. The luminance adjusting method includes following steps: obtaining an ambient luminance value by sensing ambient light via the light sensor; receiving an inputted adjusting value; adjusting the predetermined ambient luminance-light source luminance corresponding information according to the inputted adjusting value to generate first personalized ambient luminance-light source luminance corresponding information; generating an optimal luminance adjusting value by referring to the first personalized ambient luminance-light source luminance corresponding information and the ambient luminance value; and adjusting the luminance of the light source module according to the optimal luminance adjusting value.

### CROSS REFERENCE TO RELATED APPLICATIONS

This application claims the priority benefit of Taiwan application serial no. 100115140, filed on Apr. 29, 2011. The entirety of the above-mentioned patent application is hereby incorporated by reference herein and made a part of specification.

### BACKGROUND OF THE INVENTION

1. Field of Invention

The invention relates to an electronic device and, more particularly, to an electronic device and a luminance adjusting method thereof.

2. Related Art

As science technology develops, various electronic devices, such as a mobile phone, a computer, a tablet computer, a display or an electronic book, are developed to improve quality of life.

A display requires different luminance at different ambient when a user uses a mobile phone. For example, if the display is too bright in a dark room, the user's eyes may feel uncomfortable. On the contrary, if the luminance of the display is insufficient at outdoors in the daytime, it is difficult for the user to see the whole content at the screen.

As stated above, if the backlight luminance of the display is constant although the ambient light intensity changes, it is inconvenient for the user to see clearly and brings troublesome to the user. Though some conventional displays have a backlight adjusting function, the backlight luminance is adjusted according to different ambient light intensity based on a predetermined condition, which is not user friendly.

### SUMMARY OF THE INVENTION

An electronic device and a luminance adjusting method thereof are disclosed. The electronic device and the luminance adjusting method can adjust the backlight luminance with different ambient light intensity corresponding to single or multiple users' habits, which is convenient for the user to watch.

A luminance adjusting method of an electronic device is disclosed. The electronic device includes a light sensor, a control module, a memory and a light source module. The memory stores predetermined ambient luminance-light source luminance corresponding information. The luminance adjusting method includes following steps: obtaining an ambient luminance value by sensing ambient light via the light sensor; receiving a inputted adjusting value inputted by a user; adjusting the predetermined ambient luminance-light source luminance corresponding information according to the inputted adjusting value to generate first personalized ambient luminance-light source luminance corresponding information; generating an optimal luminance adjusting value by referring to the first personalized ambient luminance-light source luminance corresponding information and the ambient luminance value; and adjusting the luminance of the light source module according to the optimal luminance adjusting value, which corresponds to single or multiple users' habits and makes it easier for the user to adapt to the luminance.

An electronic device includes a light source module, a light sensor, a memory, a user interface and a control module. The light sensor senses ambient light to obtain an ambient luminance value. The memory stores predetermined ambient luminance-light source luminance corresponding information. The user interface receives an inputted adjusting value inputted by a user. The control module adjusts the predetermined ambient luminance-light source luminance corresponding information according to the inputted adjusting value to generate first personalized ambient luminance-light source luminance corresponding information, generates an optimal luminance adjusting value by referring to the first personalized ambient luminance-light source luminance corresponding information and the ambient luminance value, and adjusts the luminance of the light source module according to the optimal luminance adjusting value.

Moreover, the electronic device further includes a user interface, such as a touch control screen or a display with a keyboard or a mouse, which can receive the inputted adjusting value inputted by the user. When the user does not like the predetermined ambient luminance-light source luminance corresponding information of the electronic device, he or she can input the inputted adjusting value via the user interface. The electronic device adjusts the predetermined ambient luminance-light source luminance corresponding information according to the inputted adjusting value to generate the personalized ambient luminance-light source luminance corresponding information of the user, generates an optimal luminance adjusting value by referring to the personalized ambient luminance-light source luminance corresponding information and the ambient luminance value, and adjusts the luminance of the light source module according to the optimal luminance adjusting value.

The electronic device may also be a keyboard, a display or a mobile phone with a keyboard, and the light source module may be an illumination light source of the keyboard, the display or the mobile phone with the keyboard. An informal light source adjusting method is disclosed corresponding to single or multiple users' habits.

The predetermined ambient luminance-light source luminance corresponding information and the personalized ambient luminance-light source luminance corresponding information are presented in an equation, a reference graph or a data table. It means that the predetermined ambient luminance-light source luminance corresponding information or the personalized ambient luminance-light source luminance corresponding information is stored in the memory as an equation, a reference graph or a data table. The predetermined ambient luminance-light source luminance corresponding information or the personalized ambient luminance-light source luminance corresponding information may also be presented at the user interface as an equation, a reference graph or a data table for the user to adjust.

The inputted adjusting value inputted by the user may be generated via adjusting the luminance of the light source module in a normal mode, or generated via complicated operation, such as changing a position of a segment, inputting a plurality of points or inputting at least a value, in an expert mode. In the method of changing the position of the segment, the segment may be a part of a reference segment of the predetermined ambient luminance-light source luminance corresponding information, the use may change the position of the segment via dragging or clicking, and the segment may be a straight segment or a curve. In the method of inputting a plurality of points, the points may form a new segment, or the original segment is adjusted to pass through the points. In the method of inputting at least a value, the user may input the inputted adjusting value via filling in a table.

The memory may further store multiple groups of the personalized ambient luminance-light source luminance corresponding information, and the multiple groups of the personalized ambient luminance-light source luminance corresponding information correspond to different logins are executed on the electronic device, respectively. Thus, when different logins are executed on, the electronic device adjusts the luminance of the light source module according to the preset personalized ambient luminance-light source luminance corresponding information.

These and other features, aspects and advantages of the present invention will become better understood with regard to the following description, appended claims, and accompanying drawings.

### BRIEF DESCRIPTION OF THE DRAWINGS

FIG. 1 is a block diagram showing an electronic device in an embodiment;

FIG. 2 is a flowchart showing steps of a luminance adjusting method of the electronic device in an embodiment;

FIG. 3 is a schematic diagram showing an image displayed at an user interface wherein the image corresponds to predetermined ambient luminance-light source luminance corresponding information;

FIG. 4A is a schematic diagram showing an user interface displaying adjusted personalized ambient luminance-light source luminance corresponding information when the user feels ambient light is too weak in an embodiment;

FIG. 4B is a schematic diagram showing that an optimal luminance adjusting value is generated in accordance with the personalized ambient luminance-light source luminance corresponding information in FIG. 4A;

FIG. 4C is a schematic diagram showing an user interface displaying another adjusted personalized ambient luminance-light source luminance corresponding information when the user feels ambient light is too strong in an embodiment;

FIG. 4D a schematic diagram showing that an optimal luminance adjusting value is generated in accordance with the personalized ambient luminance-light source luminance corresponding information in FIG. 4C;

FIG. 5 and FIG. 6 are schematic diagrams showing an user interface displaying adjusted personalized ambient luminance-light source luminance corresponding information in another two embodiments; and

FIG. 7 is a flow chart showing steps of loading personalized ambient luminance-light source luminance corresponding information of different users in a luminance adjusting method of the electronic device in an embodiment.

### DETAILED DESCRIPTION OF THE INVENTION

An electronic device and a luminance adjusting method thereof in embodiments are illustrated with relating figures, and the same symbols denote the same components.

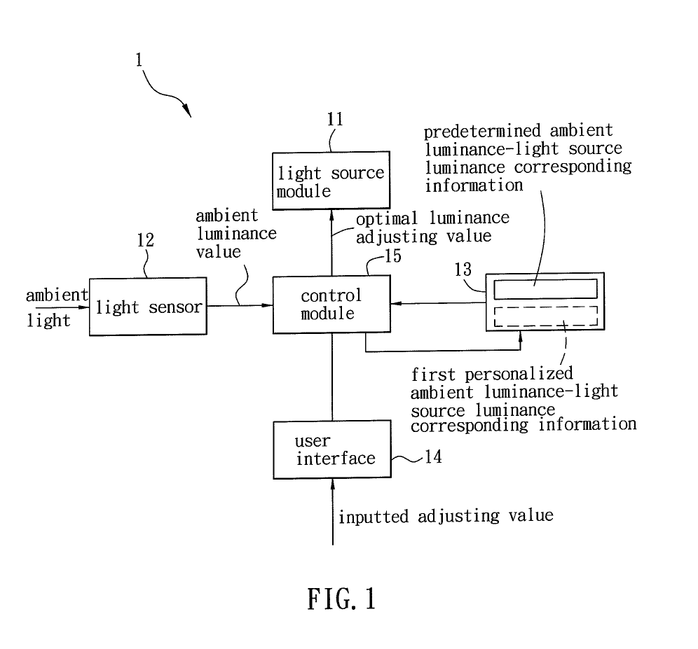

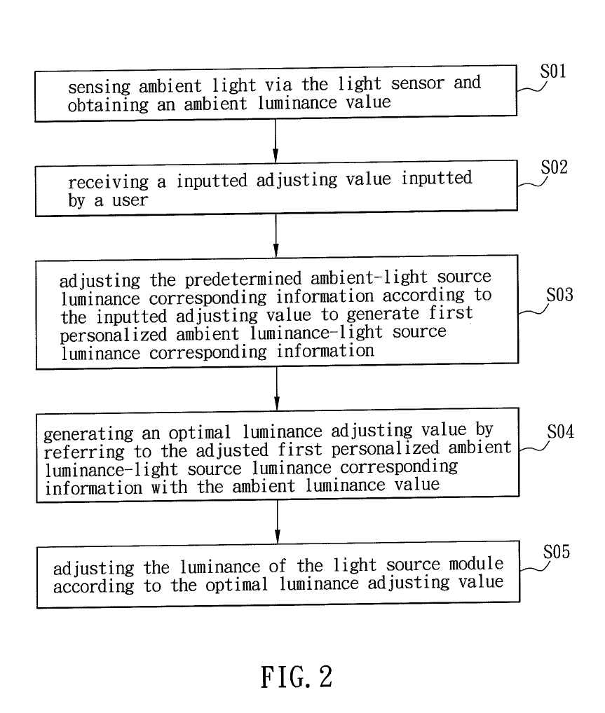

FIG. 1 is a block diagram showing an electronic device in an embodiment. The electronic device 1 includes a light source module 11, a light sensor 12, a memory 13, a user interface 14 and a control module 15. The memory 13 stores predetermined ambient luminance-light source luminance corresponding information. The predetermined ambient luminance-light source luminance corresponding information includes a corresponding relationship between the ambient light intensity and the luminance of the light source module 11 in the electronic device 1, and the electronic device 1 can automatically adjust the luminance of the light source module 11 according to the ambient light sensed by the light sensor 12. FIG. 2 is a flowchart showing steps S01 to S05 of a luminance adjusting method of the electronic device in an embodiment. The electronic device 1 and the luminance adjusting method are further illustrated accompanying FIG. 1 and FIG. 2.

The predetermined ambient luminance-light source luminance corresponding information may be stored in the memory 13 of the electronic device 1, and the predetermined ambient luminance-light source luminance corresponding information may be presented in an equation, a reference graph or a data table. If the predetermined ambient luminance-light source luminance corresponding information is presented in the reference graph, it may include position, slope, curvature and angle of a reference segment. Thus, when the user uses the electronic device 1, the light sensor 12 senses the ambient light to generate an ambient luminance value along with the change of the ambient light intensity. Then, the electronic device 1 generates a luminance adjusting value to adjust the luminance of the light source module 11 according to the preset predetermined ambient luminance-light source luminance corresponding information and the ambient luminance value sensed by the light sensor 12, and further adjusts the luminance of a display. However, if the preset predetermined ambient luminance-light source luminance corresponding information does not meet to a personal requirement, the user can use the luminance adjusting method to adjust and generate an adjusted personalized ambient luminance-light source luminance corresponding information. Different personalized ambient luminance-light source luminance corresponding information can be got via the luminance adjusting method in the embodiment.

In step S01, the light sensor 12 senses ambient light and obtains an ambient luminance value, and the ambient luminance value represents the ambient light intensity. The light sensor 12 may be a light emitting diode (LED) or a photoelectric conversion component. The ambient luminance value may be stored in the memory 13 or a register. The memory 13 may be a non-volatile memory, such as an electrically erasable programmable read-only memory (EEPROM) or a flash memory.

In step S02, an inputted adjusting value inputted by a user is received. The user inputs the inputted adjusting value via the user interface 14 of the electronic device 1. The user interface 14 may be a picture displayed by a display of the electronic device 1, and the display may be a touch control screen or a display with a keyboard and a mouse.

In step S03, the predetermined ambient luminance-light source luminance corresponding information is adjusted according to the inputted adjusting value to generate first personalized ambient luminance-light source luminance corresponding information. In step S04, an optimal luminance adjusting value is generated according to the adjusted first personalized ambient luminance-light source luminance corresponding information and the ambient luminance value. In step S05, the luminance of the light source module is adjusted according to the optimal luminance adjusting value to meet single or multiple users' habits and make it easier for the user to adapt to the luminance. The step S03 to the step S05 may be finished by the control module 15. When the user does not like the preset predetermined ambient luminance-light source luminance corresponding information of the electronic device, he or she can input the inputted adjusting value via the user interface 14 to make the control module 15 adjust the predetermined ambient luminance-light source luminance corresponding information according to the inputted adjusting value. The control module 15 generates an optimal luminance adjusting value by referring to the adjusted first personalized ambient luminance-light source luminance corresponding information and the ambient luminance value, adjusts the luminance of the light source module 11 in different ambient light according to the optimal luminance adjusting value, and further adjusts the luminance of the display or the keyboard of the electronic device. The light source module 11 may be a backlight module of the display, and it may include a cold cathode fluorescent lamp (CCFL) or a LED.

When the login is executed on the electronic device 1 again, or the user moves to a different place with different ambient light intensity, or the ambient light intensity changes, the electronic device 1 automatically adjusts the light source module 11 in different ambient light intensity according to the step S01, the step S04 and the step S05 to adjust the luminance of the display or the keyboard of the electronic device 1. In detail, when the login is executed on the electronic device 1 again, or the user moves to a different place with different ambient light intensity, or the ambient light intensity changes, the light sensor 12 senses the ambient light to obtain an ambient luminance value (step S01). Then, an optimal luminance adjusting value is generated by referring to the first personalized ambient luminance-light source luminance corresponding information and the ambient luminance value (step S04). The luminance of the light source module 11 is adjusted according to the optimal luminance adjusting value. Thus, the luminance of the display or the keyboard of the electronic device 1 is automatically adjusted according to the ambient light intensity and meets the user's habit, so as to make it easier for the user to adapt to the luminance. The user can also load and restore the predetermined ambient luminance-light source luminance corresponding information to the preset value at any time.

Furthermore, if the automatically adjusted luminance of the display or the keyboard is not appropriate for the user, he or she can modify the first personalized ambient luminance-light source luminance corresponding information via the step SO1 to the step S05. The control module 15 updates the previous personalized ambient luminance-light source luminance corresponding information according to the modified first personalized ambient luminance-light source luminance corresponding information, and the electronic device 1 can adjust the luminance of the light source module 11 in different ambient light according to the updated first personalized ambient luminance-light source luminance corresponding information. The memory 13 may store historical data of the first personalized ambient luminance-light source luminance corresponding information, and the electronic device 1 can restore to previous personalized ambient luminance-light source luminance corresponding information according to user requirements.

The control module 15 can generate an optimal luminance adjusting value according to the first personalized ambient luminance-light source luminance corresponding information and the ambient luminance value sensed by the light sensor 12, and further adjust the luminance of the light source module 11 via the optimal luminance adjusting value. The electronic device 1 can further adjust the luminance of the display or the keyboard via adjusting the luminance of the light source module 11. The electronic device may be a display, a keyboard or a mobile phone with a keyboard. The electronic device 1 can further adjust the luminance of other components with the light source module 11 via adjusting the luminance of the light source module 11. Furthermore, different components may have different predetermined ambient luminance-light source luminance corresponding information and different personalized ambient luminance-light source luminance corresponding information, respectively.

The predetermined ambient luminance-light source luminance corresponding information and the personalized ambient luminance-light source luminance corresponding information may be presented in an equation, a reference graph, or a data table. It means that the predetermined ambient luminance-light source luminance corresponding information and the personalized ambient luminance-light source luminance corresponding information is stored in the memory 13 as an equation, a reference graph or a data table. The predetermined ambient luminance-light source luminance corresponding information and the personalized ambient luminance-light source luminance corresponding information may also be presented at the user interface 14 as an equation, a reference graph or a data table for the user to adjust. Thus, the state, such as position, slope, curvature and angle of the personalized ambient luminance-light source luminance corresponding information can be changed.

The user may adjust in different ways to generate the optimal luminance adjusting value, which is not limited herein.

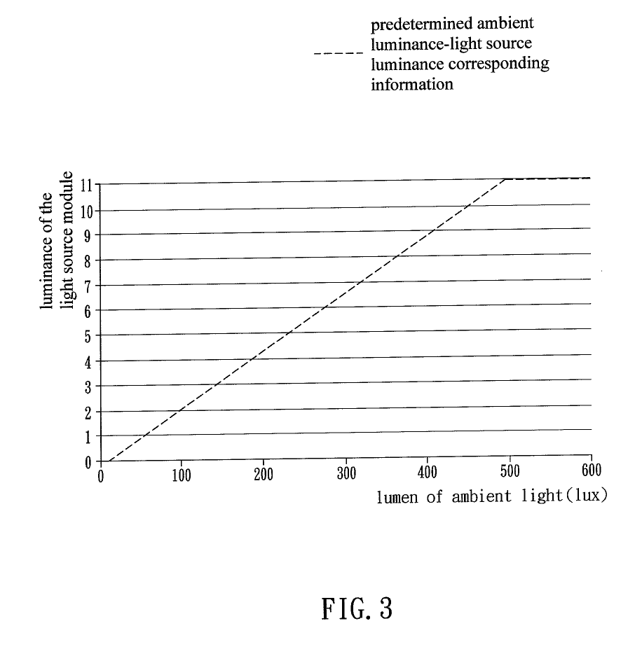

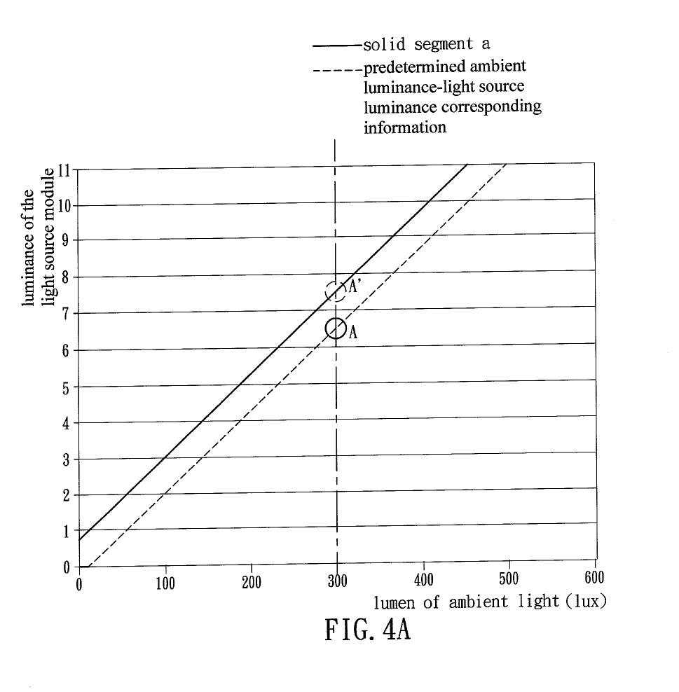

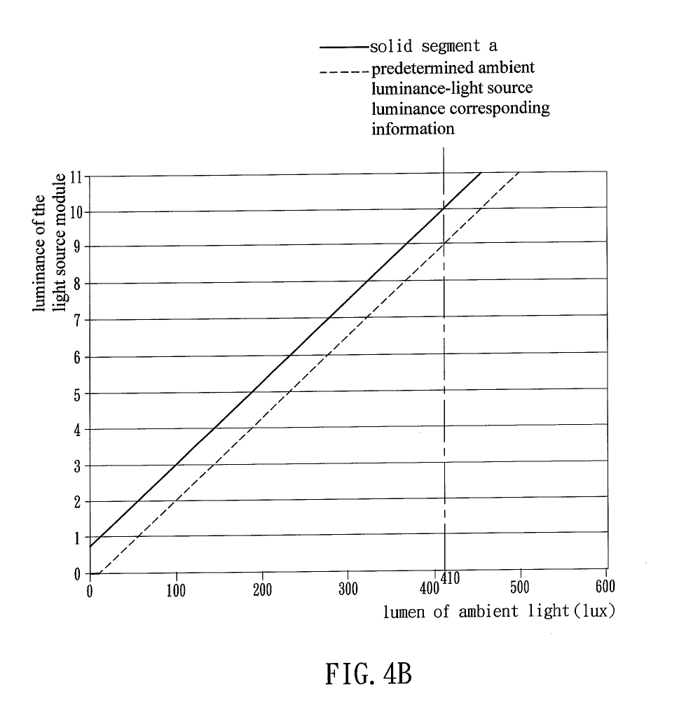

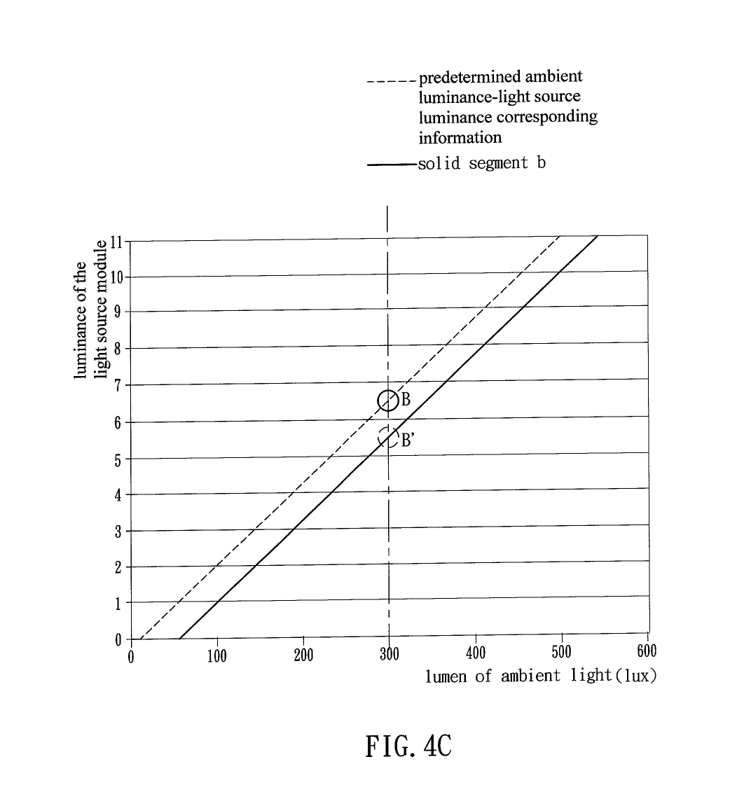

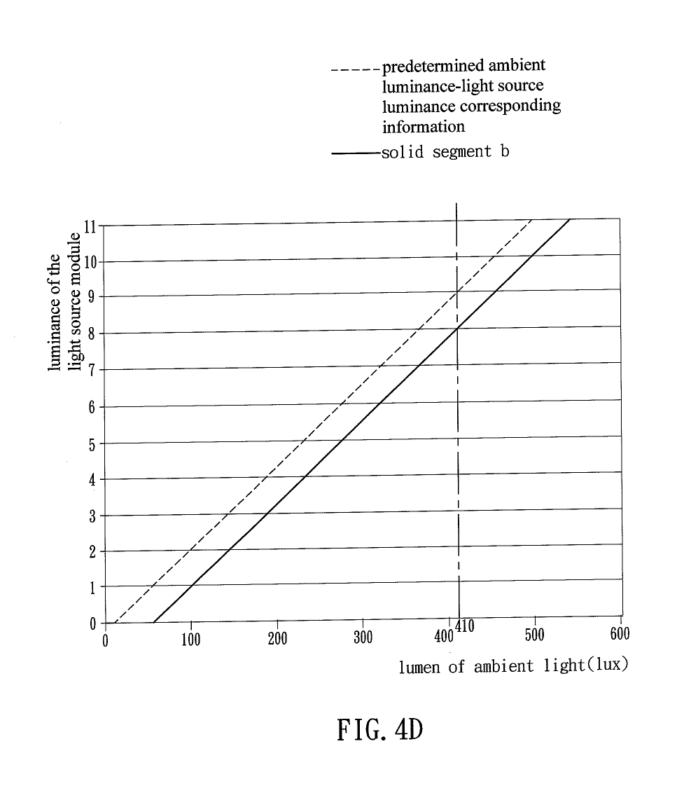

FIG. 3 is a schematic diagram showing an image displayed at the user interface 14. The user interface may be a touch control screen or a display with a keyboard and a mouse. The displayed picture includes a segment in a coordinate. The X-axis of the coordinate takes lumen (lux) of the ambient light as unit, the Y-axis takes the luminance of the light source module as unit, and values between zero to eleven are used to represent relative luminance of the light source module. The inputted adjusting value inputted by the user may be generated by adjusting the luminance of the light source module (in a normal mode), or by changing a position of a segment at the user interface 14 of the electronic device 1 (in an expert mode), and the segment may be used to show the predetermined ambient luminance-light source luminance corresponding information. The “normal mode” means the user only needs to simply adjust the luminance of the light source module (step S02), and the electronic device 1 can automatically execute the other steps in the background (steps S01, S03, S04 and S05). The “expert mode” means the user can input the inputted adjusting value via the user interface 14 (step S02) and adjust the predetermined ambient luminance-light source luminance corresponding information to generate the personalized ambient luminance-light source luminance corresponding information (step S03). Thus, the user can obtain the personalized ambient luminance-light source luminance corresponding information meeting to requirements better. As shown in FIG. 4A, the user can change the position of the segment by dragging and clicking, and the segment may be a straight segment or a curve. “Dragging” means that the user drags one point of the segment to another point, or click on another point on the coordinate to generate a change reference point, and the segment is adjusted to pass through the change reference point. The X-axis value of the change reference point may represent lumen of the ambient light sensed by the light sensor 12 of the electronic device 1, and the Y-axis value of the change reference point represents the inputted adjusting value.

FIG. 4A is a schematic diagram showing personalized ambient luminance-light source luminance corresponding information (shown in a solid segment a) after the adjustment when the user feels the ambient light is too weak, and the preset predetermined ambient luminance-light source luminance corresponding information is shown in a dotted segment. If the light sensor senses the ambient light and obtains that the ambient luminance value is 300 lux, the corresponding luminance of the light source module is 6.5 according to a reference point A of the predetermined ambient luminance-light source luminance corresponding information. When the user feels the luminance of the display is too weak, he or she can click on the reference point A and drag it to the position of the change reference point A′ at which the ambient luminance value is 300 lux and the corresponding luminance of the light source module is 7.5. The segment (shown in a dotted segment) of the predetermined ambient luminance-light source luminance corresponding information is moved upwards to form a segment (shown in a solid segment a) of the personalized ambient luminance-light source luminance corresponding information passing through the change reference point A′. Then, the control module 15 stores the personalized ambient luminance-light source luminance corresponding information corresponding to the solid segment to the memory 13.

Then, the control module 15 can generate the optimal luminance adjusting value according to the personalized ambient luminance-light source luminance corresponding information of the solid segment a and the real-time ambient luminance value, and further adjusts the luminance of the light source module 11. FIG. 4B is a schematic diagram showing an optimal luminance adjusting value. If the light sensor 12 senses an ambient luminance value of the ambient light as 410 lux at a time, the corresponding optimal luminance adjusting value is 10 at the solid segment a. The control module 15 adjusts the luminance of the light source module 11 according to the optimal luminance adjusting value.

FIG. 4C is a schematic diagram showing another personalized ambient luminance-light source luminance corresponding information (shown in a solid segment b) after the adjustment when the second user feels the luminance of the display is too strong, and the preset predetermined ambient luminance-light source luminance corresponding information is shown in a dotted segment. If the light sensor senses the ambient light and obtains that the ambient luminance value is 300 lux, the corresponding luminance of the light source module is 6.5 according to a reference point B of the predetermined ambient luminance-light source luminance corresponding information. When the second user feels the luminance of the display is too strong, he or she can click on the reference point B and drag it to the position of a change reference point B′ at which the ambient luminance value is 300 lux and the corresponding luminance of the light source module is 5.5. The segment (shown in a dotted segment) of the predetermined ambient luminance-light source luminance corresponding information is moved downwards to form a segment (shown in a solid segment b) of the personalized ambient luminance-light source luminance corresponding information passing through the change reference point B′. Then, the control module 15 stores the personalized ambient luminance-light source luminance corresponding information corresponding to the solid segment b to the memory 13.

Then, the control module 15 can generate the optimal luminance adjusting value according to the personalized ambient luminance-light source luminance corresponding information of the solid segment b and the real-time ambient luminance value, and further adjusts the luminance of the light source module 11. FIG. 4D is a schematic diagram showing an optimal luminance adjusting value. If the light sensor 12 senses an ambient luminance value of the ambient light as 410 lux at a time, the corresponding optimal luminance adjusting value is 8 at the solid segment b. The control module 15 adjusts the luminance of the light source module 11 according to the optimal luminance adjusting value.

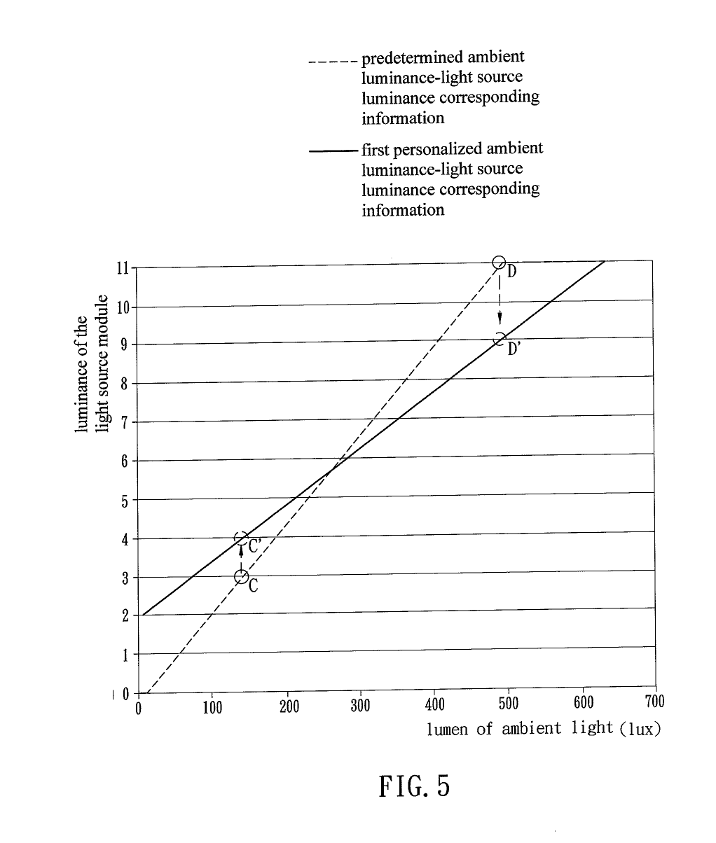

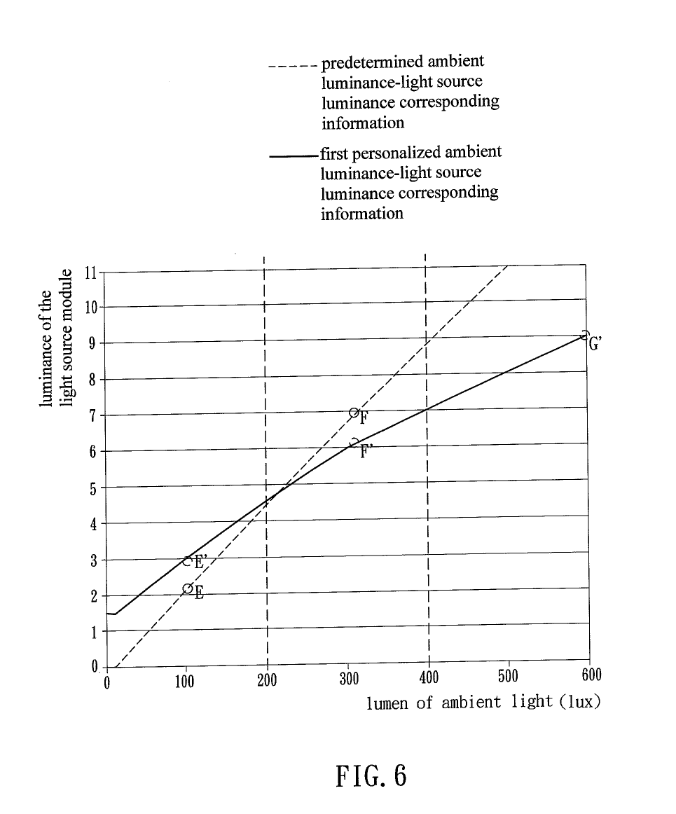

FIG. 5 and FIG. 6 are schematic diagrams showing a complicated user interface, at which the user can input a plurality of inputted adjusting values to adjust the preset predetermined ambient luminance-light source luminance corresponding information.

As shown in FIG. 5, the inputted adjusting value is inputted by receiving a plurality of reference points at the user interface of the electronic device. For example, the user drags two reference points C and D in FIG. 5 to the positions of the change reference points C′ and D′ to adjust the preset predetermined ambient luminance-light source luminance corresponding information and further generate the first personalized ambient luminance-light source luminance corresponding information passing through the change reference points C′ and D′. The change reference points may form a new segment, or the preset segment can be adjusted to pass through the change reference points. The change reference points forming a new segment are taken as an example in FIG. 5. If the preset segment is adjusted to pass through the change reference points, for example, the start point and the end point of the segment are not changed and the middle part of the segment is adjusted to pass through the change reference points, which forms a curve or multiple segments connected to each other and in different slopes.

As shown in FIG. 6, the user selects two reference points E and F, moves the two reference points to the positions of two change reference points E′ and F′, and selects another change reference point

G′ as the inputted adjusting value. In FIG. 6, the control module 15 divides the X-axis into three intervals, 0 to 200 lux, 200 to 400 lux and 400 to 600 lux, three new segments are formed in the three intervals according to the change reference points E′, F′ and G′, and a segment of the first personalized ambient luminance-light source luminance corresponding information passing through the change reference points E′, F′ and G′ is further generated.

New personalized ambient luminance-light source luminance corresponding information also may be generated by inputting at least a value at the user interface 14 of the electronic device or filling in a table, which is not limited herein. Then, the optimal luminance adjusting value is generated, and the luminance of the light source module 11 is adjusted via the optimal luminance adjusting value.

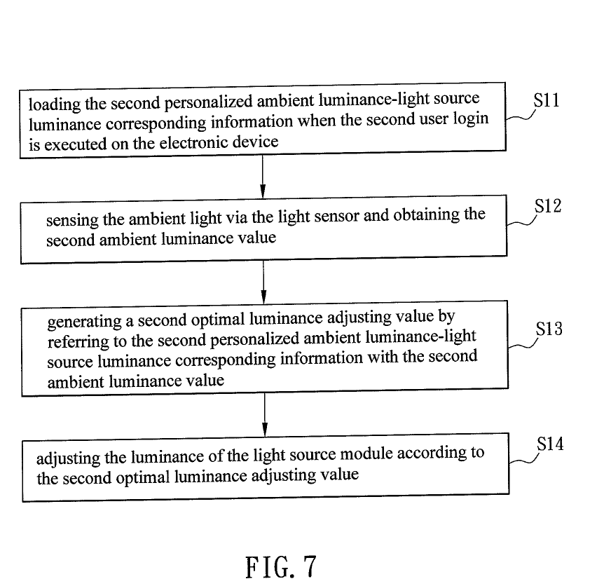

The memory 13 can further store multiple groups of the personalized ambient luminance-light source luminance corresponding information (such as the first personalized ambient luminance-light source luminance corresponding information and the second personalized ambient luminance-light source luminance corresponding information and so on), and the multiple groups of the personalized ambient luminance-light source luminance corresponding information correspond to different logins are executed on the electronic device, respectively. Consequently, when different logins are executed on the electronic device, the electronic device adjusts the luminance of the light source module according to the preset personalized ambient luminance-light source luminance corresponding information. As shown in FIG. 7, the luminance adjusting method further includes: loading a second personalized ambient luminance-light source luminance corresponding information when a second login is executed on the electronic device (step S11); sensing the ambient light via the light sensor and obtaining a second ambient luminance value (step S12); generating a second optimal luminance adjusting value by referring to the second personalized ambient luminance-light source luminance corresponding information and the second ambient luminance value (step S13); and adjusting the luminance of the light source module according to the second optimal luminance adjusting value (step S 14). As stated above, the electronic device 1 may store multiple groups of the personalized ambient luminance-light source luminance corresponding information corresponding to multiple users, respectively. Consequently, when different logins are executed on the electronic device 1, the electronic device 1 automatically loads the corresponding personalized ambient luminance-light source luminance corresponding information, adjusts the luminance of the light source module for the user and further adjusts the luminance of the display or the keyboard of the electronic device 1 correspondingly.

As stated above, the electronic device stores the predetermined ambient luminance-light source luminance corresponding information which includes a corresponding relationship between the luminance of the ambient light and the luminance of the light source module in the electronic device. The electronic device senses the ambient light via a light sensor, automatically adjusts the luminance of the light source module according to the predetermined ambient luminance-light source luminance corresponding information or the adjusted personalized ambient luminance-light source luminance corresponding information (such as the first personalized ambient luminance-light source luminance corresponding information), and further adjusts the luminance of the display. As a result, it is convenient for the user to see clearly in different circumstances, and the informal luminance optimizing adjusting method corresponds to single or multiple users' habits.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A luminance adjusting method of an electronic device, wherein the electronic device includes a light sensor, a control module, a memory and a light source module, and the memory stores predetermined ambient luminance-light source luminance corresponding information, the luminance adjusting method comprising following steps:
obtaining an ambient luminance value by sensing ambient light via the light sensor;
receiving an inputted adjusting value;
adjusting the predetermined ambient luminance-light source luminance corresponding information according to the inputted adjusting value to generate a first personalized ambient luminance-light source luminance corresponding information;
generating an optimal luminance adjusting value according to the first personalized ambient luminance-light source luminance corresponding information and the ambient luminance value; and
adjusting the luminance of the light source module according to the optimal luminance adjusting value.

2. The luminance adjusting method of the electronic device according to claim 1, wherein the predetermined ambient luminance-light source luminance corresponding information or the first personalized ambient luminance-light source luminance corresponding information are presented in an equation, a reference graph or a data table.

3. The luminance adjusting method of the electronic device according to claim 1, wherein the inputted adjusting value is inputted by changing a position of a segment at a user interface of the electronic device.

4. The luminance adjusting method of the electronic device according to claim 1, wherein the inputted adjusting value is inputted by receiving a plurality of points at a user interface of the electronic device.

5. The luminance adjusting method of the electronic device according to claim 1, wherein the inputted adjusting value is inputted by receiving at least a value at a user interface of the electronic device.

6. The luminance adjusting method of the electronic device according to claim 1, wherein the memory further stores a second personalized ambient luminance-light source luminance corresponding information, and the luminance adjusting method further includes:
loading the second personalized ambient luminance-light source luminance corresponding information when a login is executed on the electronic device;
sensing the ambient light by the light sensor to get a second ambient luminance value;
generating a second optimal luminance adjusting value according to the second personalized ambient luminance-light source luminance corresponding information and the second ambient luminance value; and
adjusting the luminance of the light source module according to the second optimal luminance adjusting value.

7. An electronic device, comprising:
a light source module;
a light sensor sensing ambient light to obtain an ambient luminance value;
a memory storing predetermined ambient luminance-light source luminance corresponding information;
a user interface receiving an inputted adjusting value; and
a control module adjusting the predetermined ambient luminance-light source luminance corresponding information according to the inputted adjusting value to generate a first personalized ambient luminance-light source luminance corresponding information, generating an optimal luminance adjusting value according to the first personalized ambient luminance-light source luminance corresponding information and the ambient luminance value, and adjusting the luminance of the light source module according to the optimal luminance adjusting value.

8. The electronic device according to claim 7, wherein the predetermined ambient luminance-light source luminance corresponding information or the first personalized ambient luminance-light source luminance corresponding information is presented in an equation, a reference graph or a data table.

9. The electronic device according to claim 7, wherein the inputted adjusting value is inputted via receiving at least a value at the user interface.

10. The electronic device according to claim 7, wherein the memory further stores a second personalized ambient luminance-light source luminance corresponding information, when a login is executed on the electronic device, the control module loads the second personalized ambient luminance-light source luminance corresponding information, generates the second optimal luminance adjusting value according to the second personalized ambient luminance-light source luminance corresponding information and the second ambient luminance value sensed by the light sensor, and adjusts the luminance of the light source module according to the second optimal luminance adjusting value.
